(19) United States
(12) Patent Application Publication
(10) Pub. No.: US 2006/0218860 A1
(43) Pub. Date: Oct. 5, 2006

(54) System 4000 - Hydroponics System

(76) Inventor: Gabriel Paul DeFrancesco, Exeter, RI (US)

Correspondence Address: GABRIEL DEFRANCESCO, 87 HALLVILLE ROAD, EXETER, RI, 02822, US

(21) Appl. No.: 10/907,108

(22) Filed: Mar. 21, 2005

(51) Int. Cl. A01G 31/02

(52) U.S. Cl. 47/62 R

(57) ABSTRACT

The present invention relates to the field of hydroponics plant growth in cylindrical pipe bodies or conduit units. This invention solves three current operating problems in these hydroponics units: (1) Easy observation of the nutrient level and root systems in the main reservoir, (2) Direct access to and cleaning of the unit interior without disturbing the ongoing operation of the system, and (3) A method to adjust the interior liquid nutrient level and/or drain the system contents. In the present embodiment, the main body of the hydroponics unit consists of a 6-inch diameter PVC pipe body (reservoir) with four growth sites. The pipe body is capped at one end with a 6 inch-diameter threaded female adapter with cleanout plug, and at the other end with a transparent Plexiglas window to permit observation of root growth and nutrient solution levels in the reservoir. Interior to the main body reservoir is an 80-gallon per hour, 120 volt submersible recirculation pump which feeds nutrient solution to the net pots via ¼ inch diameter plastic tubing and fittings. The main body reservoir is supported on four one-inch diameter PVC legs, approximately 8 inches high. A ½ inch ¼ turn PVC drain valve is located at the bottom of the main body reservoir to permit draining and fluid level adjustments as needed.

### FIELD OF THE INVENTION

This invention is directed to improvements and attachments that can be fitted to a hydroponics pipe cylinder or conduit system to improve the operation, maintenance, and versatility of the system. In one form, one improvement allows direct observation of the contents of the hydroponics cylinder system through a Plexiglas view port; another form or improvement allows direct and easy access to and cleaning of the system interior via a threaded clean-out adapter; and a third improvement allows for adjustment of the interior nutrient level and drainage of the main body conduit; all improvements and attachments such that the hydroponics system never needs to be disassembled or taken out of operation while operating or maintaining the hydroponics system.

### BACKGROUND ART

Typically, hydroponics involves growing plants in the absence of a soil medium, and a manufactured, self contained, small-scale hydroponics system is used for growing various plants, to include herbs, vegetables, fruits, and/or flowers. The required nutrients and water are usually delivered by a pumped system to the plant root system in a recirculating solution form that passes over or through the root portion of the plant.

Hydroponics has advantages over more conventional gardening that include the ability to carefully control feeding and nutrient flow rates, elimination of weeds, and improved control of pests and diseases.

One of the potential limitations of the hydroponics systems described above is that it can be very difficult to observe the necessary reservoir and nutrient levels in the main body cylinder.

Another potential limitation is the inability to drain and/or clean out the main body without removing or disturbing the entire system and/or plant roots.

These limitations may result in much extra work and frustration when operating such a system.

### OBJECT OF THE INVENTION

In one aspect, the present invention provides for attachments that can be fitted to a hydroponics pipe cylinder or conduit of suitable dimensions and form that improve the operation, maintenance, and versatility of the system.

In one embodiment, a Plexiglas view port allows direct observation of the contents of the hydroponics system.

In another embodiment, a suitably sized PVC female adapter with threaded plug allows direct and easy cleaning.

In another embodiment, a PVC ball valve, located at a suitable location, permits drainage and/or adjustment of the interior water and nutrient level.

All of the above embodiments are such that the growing plants and the main hydroponics pipe cylinder, conduit, or unit never need to be disturbed, disassembled, or taken out of operation while operating or maintaining the hydroponics system. The exact type or form of hydroponics conduit need not form part of the invention except that it is used as a support for the attachment embodiments that do form part of the invention.

### SUMMARY OF INVENTION

The present invention configuration consists of a 6-inch diameter Poly Vinyl Chloride (PVC) pipe main body reservoir with four sites for growing plants in net baskets, but the main body diameter, length, quantity, and number of basket sites may vary.

The main body reservoir is capped at one end with a 6 inch-diameter threaded female PVC adapter with cleanout plug, and at the opposite end with a transparent Plexiglas window or view port to permit observation of root growth and nutrient solution levels in the main body reservoir.

Interior to the main body reservoir is an 80-gallon per hour, 120 volt submersible recirculation pump which feeds nutrient solution to the net baskets or pots via a manifold assembly of ¼ inch diameter plastic tubing and fittings.

The main body reservoir is supported on four one-inch diameter PVC legs, approximately 8 inches high. This height permits a ½ inch ¼ turn PVC drain valve to be located at the bottom of the main body reservoir to permit draining and fluid level adjustments as needed, while the unit is in operation, and without disassembling the unit.

### BRIEF DESCRIPTION OF THE DRAWINGS

Parts numbered in drawings:
01 Main system body (or reservoir) made of six-inch diameter SDR35 Poly Vinyl Chloride (PVC) pipe material.
02 Transparent one-eighth inch thick Plexiglas view port/window.
03 Six-inch diameter SDR35 PVC threaded female adapter.
04 One-quarter turn PVC drain valve.
05 Three-inch diameter hole in main body unit.
06 One-inch diameter PVC leg assemblies.
07 Six-inch diameter threaded end cap.
08 80 gallon per hour submersible pump, 120 VAC.
09 One-quarter inch diameter PVC tubing manifold assembly.
10 Three inch diameter net pot or basket with clay aggregate.
11 Power supply cord to submersible pump.

An embodiment of the invention will be described with reference to the following drawings in which:

FIG. 1. Illustrates an elevation view of the locations of the separate invention embodiments, 02, and 03, located at the ends of a typical hydroponics pipe cylinder or conduit unit, according to an embodiment of the invention.

FIG. 2. Illustrates a plan view of view, the location of the separate embodiments 02, and 03, to supplement the view of FIG. 1 and FIG. 2.

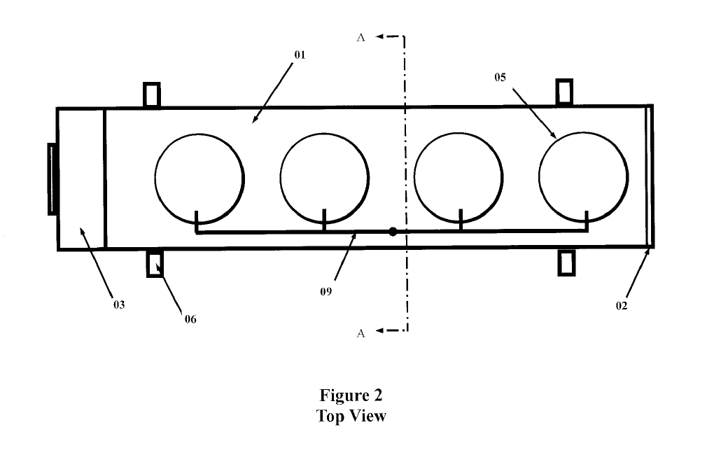

FIG. 3. Illustrates in an end view the transparent Plexiglas view port or window, embodiment 02, of the invention of FIG. 1 and FIG. 2. This view also shows the inclusion of a fluid level line drawn on the surface of the view port or window that allows the operator of the system to know immediately whether the liquid nutrient level in the main body reservoir is at the proper level or elevation.

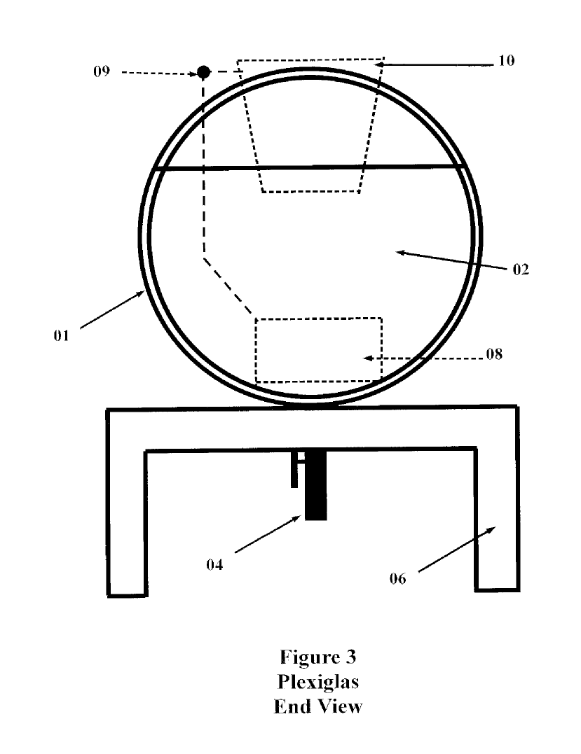

FIG. 4. Illustrates in an end view the PVC female clean-out adapter with threaded plug, embodiment 03, of the invention of FIG. 1 and FIG. 2. This female adapter is a standard industry PVC pipe accessory and is of standard manufacture. This view also shows a square knob that is part of the threaded plug portion of the female adapter, which allows the operator to grip the threaded plug easily for either tightening or loosening activities.

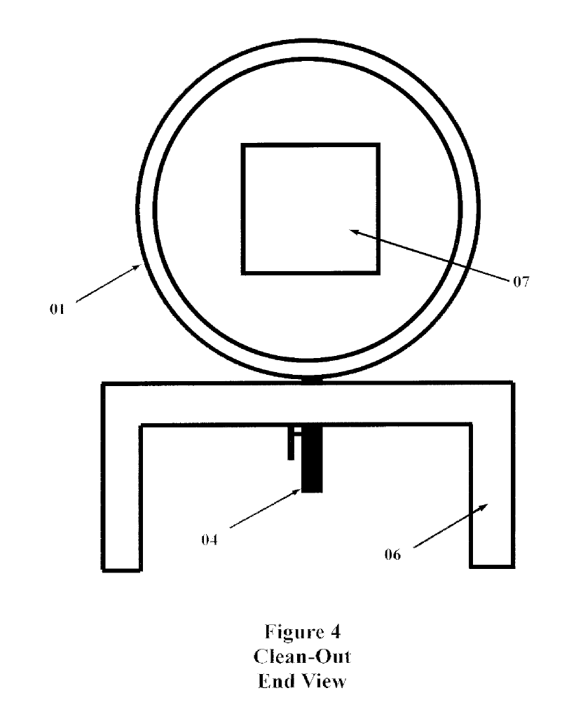

FIG. 5. Illustrates in section view, a cross-section A-A of the typical hydroponics pipe cylinder or conduit of FIG. 1 and FIG. 2. This view shows the location of an interior submersible 80-gallon per hour pump used to circulate the nutrient liquid level from the reservoir up to the plant baskets or pots via a ¼ inch-diameter plastic tubing manifold assembly.

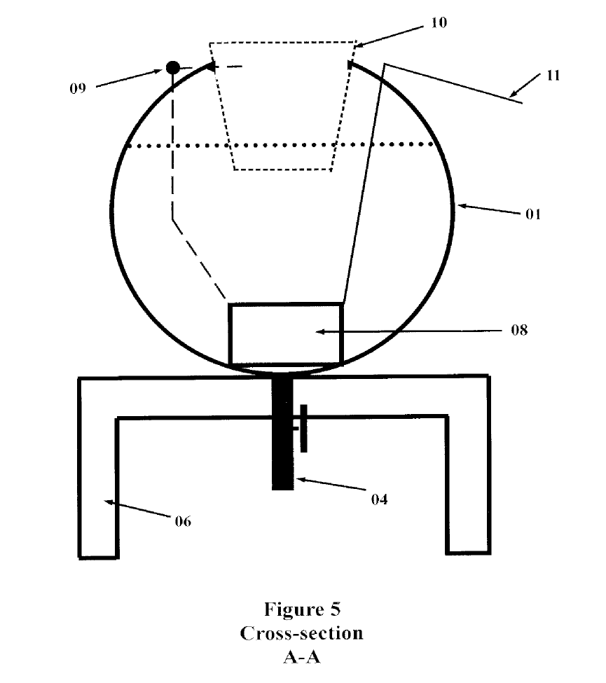

### BEST MODE

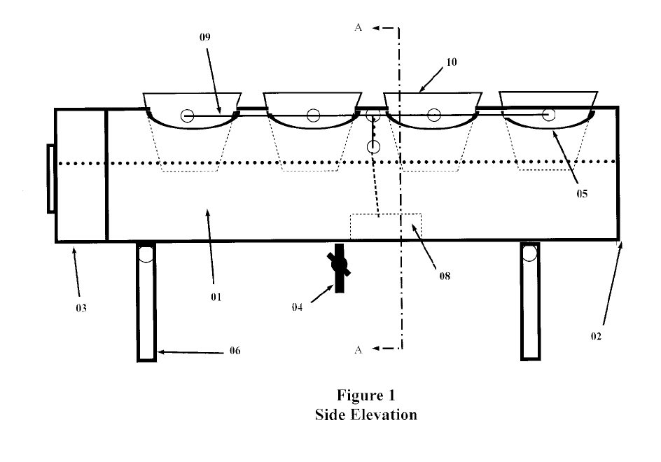

Referring to the figures, and initially to FIG. 1, there is illustrated an attachment according to an embodiment of the invention which comprises two parts: being a ⅛ inch thick transparent Plexiglas or equivalent material 02 attached with a two part epoxy glue to the main pipe cylinder or conduit (illustrated as arrow 02), and a six-inch diameter PCV female adapter 03 with matching threaded plug 07, also attached to the main pipe cylinder with two part epoxy glue (illustrated as arrow 03); with both 02 and 03 suitably attached to the pipe cylinder with two part epoxy glue so as to be water tight to prevent any leakage of the interior fluid level from either end.

Referring to hydroponics pipe cylinder or conduit 01, this conduit is known and in the embodiment comprises a circular PVC pipe of suitable length. The pipe 01 is provided with a number of spaced apart linearly aligned circular openings 05 which are used to house plastic net baskets or pots 10 for growing plants in a hydroponics manner.

To provide stability and suitable height, the hydroponics pipe cylinder 01 is supported on one-inch diameter PVC legs 06 as shown, and at a suitable height (minimum of 8 inches) and width (minimum of 8 inches). This configuration permits access to, and operation of, a ¼ turn ¾ inch-diameter PVC drain valve 04.

### ALTERNATIVE EMBODIMENTS

In the embodiment shown, the main system reservoir, 01, consists of a suitable length of PVC pipe or conduit with growth sites 05 for four net pots 10. With the addition of a second similar pipe or conduit of similar length, the system size can double as additional growth sites are added, thus allowing much flexibility and expansion of the system. This is merely one possible embodiment of this invention. However, there are many more possible configurations. For example, instead of second pipe or conduit of similar length for four net pot sites, a longer pipe or conduit could be used if more than four growth sites are desired on only one pipe cylinder or conduit.

What is claimed is:

1. An attachment for a hydroponics circular pipe or conduit, the attachment comprising a transparent Plexiglas window or view port at one end of the main body cylinder to permit visual observation and continuous monitoring of nutrient liquid levels and plant root development while the unit is in operation.

2. An attachment for a hydroponics circular pipe or conduit, the attachment comprising a 6 inch-diameter threaded female adapter at the opposite end of the reservoir body to permit direct access for cleaning and maintenance of the system while it is in operation and without requiring removal of the plants.

3. An attachment for a hydroponics circular pipe or conduit, the attachment comprising a one-quarter (¼ ) turn, three-quarter (¾ ) inch diameter PVC ball valve at the body of the main system reservoir or pipe to permit easy adjustment and drainage of the interior fluid nutrient levels without disturbing the growing plants, their root systems, or the overall hydroponics system in any way.
